(19) United States
(12) Patent Application Publication
(10) Pub. No.: US 2024/0282473 A1
(43) Pub. Date: Aug. 22, 2024

(54) METHOD FOR ONLINE RADIOISOTOPE MEASUREMENT FOR FAILED FUEL CHARACTERIZATION IN PRIMARY SODIUM SYSTEMS

(71) Applicant: TerraPower, LLC, Bellevue, WA (US)

(72) Inventors: Jesse R. Cheatham, III, Seattle, WA (US); Christopher M. Reagan, Seattle, WA (US); John E. Truax, Bonney Lake, WA (US); Jacob Wilcox, Arlington, WA (US)

(21) Appl. No.: 18/393,377

(22) Filed: Dec. 21, 2023

Related U.S. Application Data
(60) Provisional application No. 63/447,321, filed on Feb. 21, 2023.

(51) Int. Cl. G21C 17/022; G21C 17/00

(52) U.S. Cl. CPC G21C 17/022; G21C 17/002

(57) ABSTRACT

A failed fuel pin emits cesium into the primary sodium coolant and xenon into the cover gas in a reactor vessel. A pipe containing radioactive liquid sodium accepts flowing primary sodium from the reactor vessel. A radiation detector is positioned adjacent the pipe such that gamma radiation emitted from the pipe can be measured. The pipe may be isolated to increase detection limits by allowing short-lived isotopes to decay. The isotopic ratio of ¹³⁷Cs/¹³⁴Cs can be measured, which can be used to determine the burnup of a fuel assembly from within the core, and therefore, the failed fuel assembly can be identified based at least in part on the burnup. Further, mass spectrometry may be used to measure the ratio of a stable and unstable xenon isotope. The identification techniques may be used in conjunction to quickly identify a failed fuel assembly in-situ and during reactor operation.

### GOVERNMENT LICENSE RIGHTS

This invention was made with government support under DOE Cooperative Agreement No. DE-NE0009054 awarded by the U.S. Department of Energy. The government has certain rights in the invention.

### BACKGROUND

In a sodium-cooled fast reactor (“SFR”), the reactor components include a reactor vessel filled with a liquid sodium coolant and a reactor core. In some cases, an SFR is a once-through fast reactor that runs on subcritical reload fuel that is bred up and burned in situ. The reactor core is immersed in the sodium pool in the reactor vessel. In some designs, the core may include fuel pins bundled into fuel assemblies that contain fissile fuel and fertile fuel that may be bred up into fissile fuel. Within the reactor core, the fuel pins undergo significant stress and strain due to mechanical stresses and strains as well as due to thermal stresses, neutron damage, and internal fuel pin forces due to fissioning. In some cases, one or more of the fuel pins may fail, such as by leaking fertile fuel, fissile fuel, and/or fission products into the primary sodium.

Typically, a fuel pin failure is a breach in the fuel pin cladding that allows direct contact between the primary coolant and the nuclear fuel. This contact may cause a reaction between the oxide fuel and the sodium, which can lead to the formation of an uranoplutonate phase which can further lead to fuel swelling and the potential for further degradation of the fuel pin. Furthermore, in reactors that rely on metal fuel, fission products can leech out of the fuel. In particular, cesium is collected in the sodium bond of the metal fuel and cesium vapor is collected in the gas plenum. The cesium can be ejected upon a pin failure.

Typically, delay neutrons and cover gas analysis have been used for detecting the presence of a failure. However, locating the failed fuel element can be problematic. For example, triangulation using delay neutron detectors, flux tilting, sodium sampling, wet sipping, and dry sipping are all techniques that have been tried to varying degrees of success.

For instance, dry sipping requires a fuel assembly to be lifted completely out of the sodium pool and is allowed to heat up in a sealed container by disrupting the cooling. This can be supplemented by pulling a vacuum on the fuel assembly to create a pressure differential and “burp” the fuel assembly. Wet sipping requires the fuel pin to be pressurized in order to vent fission gasses. Wet sipping typically occurs by blocking the outlet of an assembly to reduce cooling which will heat and build pressure within the fuel pins. Failed fuel pins will push out additional fission product inventory that can subsequently be sampled. Sodium sampling allows a fuel pin to remain in place and a sodium sample is taken from above the fuel assembly and analyzed using delay neutron detectors. However, each of these methods has disadvantages and it would be advantageous to be able to ascertain the presence of a failed fuel pin and the location of the failed fuel pin in an efficient way without affecting the reactor operation in order to do so.

### SUMMARY

According to some embodiments, a method for characterizing a failed fuel assembly in a nuclear reactor, includes the steps of flowing a primary sodium coolant to a bypass pipe; determining an isotopic ratio of ¹³⁷Cs/¹³⁴Cs; determining, based at least in part on the isotopic ratio, a burnup of the failed fuel assembly; and determining, based at least in part on the burnup, an identification of the failed fuel assembly. Determining the isotopic ratio may be performed by gamma spectroscopy. Furthermore, the method may be performed without removing primary sodium coolant from a closed system comprising a nuclear reactor vessel and the bypass pipe. In other words, the method may be carried out in-situ. In some cases, a cover gas in a reactor vessel is analyzed to detect a fission product in the cover gas, in order to determine that a fuel assembly has failed. Determining the isotopic ratio may be performed by mass spectroscopy. In some instances, the method further includes the step of providing a tag gas to one or more fuel elements within a fuel assembly. Providing a tag gas may include providing a plurality of unique tag gases and wherein a number of unique tag gases is less than a number of fuel assemblies located within a nuclear reactor core. In other words, a first unique tag gas may be applied to a first group of fuel assemblies, a second unique tag gas may be applied to a second group of fuel assemblies, and so on. In some embodiments, the method is carried out during reactor operation. Determining an identification of the failed fuel assembly may include the step of determining a subset of the fuel assemblies, the subset of the fuel assemblies comprising one or more of the failed fuel assemblies. The method may further include the step of analyzing ones of the subset of the fuel assemblies to determine a failed fuel assembly, which may include a lift and burp technique. Lift and burp occurs by hydro static pressure and potential increased temperature by removing the assembly from a forced flow path within the core. In some cases, the method may include the step of isolating the sodium coolant in the bypass pipe.

According to some embodiments, a system includes a nuclear reactor core; a plurality of fuel elements disposed in the reactor core; a volume of primary sodium coolant in contact with the plurality of fuel elements; a sodium processing cell external to the nuclear reactor core, the sodium processing cell in fluid communication with the nuclear reactor core by sodium processing piping; a detector adjacent the sodium processing piping, the detector configured to detect radioactive emissions of isotopes that escaped from a failed fuel assembly; one or more processors configured with instructions that, when executed by the one or more processors, cause the processors to determine isotopic ratios of the isotopes; determine, based at least in part on the isotopic ratios, a burnup of the failed fuel assembly; and determine, based at least in part on the burnup of the failed fuel assembly, a location of the failed fuel assembly within the nuclear reactor core.

The system may include a plurality of unique tag gases located within selected ones of the plurality of fuel elements disposed in the reactor core. For example, a first tag gas may be provided in a first group of fuel assemblies and a second tag gas may be provided to a second group of fuel assemblies. In other words, the number of unique tag gases may be less than the number of fuel assemblies.

In some cases, the detector is configured to detect gamma emissions from the isotopes that escaped from a failed fuel assembly through gamma spectroscopy. In some embodiments, the isotopes that escaped from a failed fuel assembly are one or more of xenon isotopes or cesium isotopes. In some cases, the isotopic ratio is ¹³⁷Cs/¹³⁴Cs.

According to some embodiments, a method for locating a failed fuel assembly in a nuclear reactor includes the steps of determining that a fuel assembly has failed; flowing a primary coolant adjacent to a detector; determining, with the detector, an isotopic ratio of fission product isotopes in the primary coolant; determining, based on the isotopic ratio, a burnup of the failed fuel assembly; and determining, based on the burnup of the failed fuel assembly and through core modeling and fuel assembly tracking, a location of the failed fuel assembly within the nuclear reactor. In some instances, the isotopic ratio is ¹³⁷Cs/¹³⁴Cs. The isotopic ratio of fission product isotopes in the primary coolant may be determined by measuring gamma emissions. In some cases, the method is performed while the nuclear reactor is operating. Furthermore, the method may be performed without removing primary coolant from a closed coolant loop.

In some examples, the step of determining, with the detector, an isotopic ratio of fission product isotopes in the primary coolant is performed on a flowing volume of sodium. This allows a real-time online measurement of isotopic ratios. In some cases, the method further includes the step of detecting a tag gas from a failed fuel assembly.

According to some embodiments, a method for identifying a failed fuel assembly in a nuclear reactor core includes the steps of, in no particular order, determining that a fuel assembly has failed; down selecting the possible failed fuel assemblies to a first subset of fuel assemblies by using isotopic ratios to determine burnup; down selecting the first subset to a second subset of fuel assemblies by using a tag gas; determining, based at least in part on the burnup and the tag gas, the failed fuel assembly.

In some cases, burnup is determined by using gamma spectroscopy to detect an isotopic ratio. The method may be performed in-situ and without removing a volume of sodium coolant from the nuclear reactor core. In some cases, determining that a fuel assembly has failed is performed by analyzing a cover gas in a reactor vessel and detecting a fission product in the cover gas.

In some examples, using a tag gas comprises providing a first tag gas to a first group of fuel assemblies, providing a second tag gas to a second group of fuel assemblies, and providing a third tag gas to a third group of fuel assemblies.

The method may be carried out during reactor operation. In some cases, the method further includes the step of analyzing the second subset of fuel assemblies using a lift and burp technique.

### BRIEF DESCRIPTION OF THE DRAWINGS

The accompanying drawings are part of the disclosure and are incorporated into the present specification. The drawings illustrate examples of embodiments of the disclosure and, in conjunction with the description and claims, serve to explain, at least in part, various principles, features, or aspects of the disclosure. Certain embodiments of the disclosure are described more fully below with reference to the accompanying drawings. However, various aspects of the disclosure may be implemented in many different forms and should not be construed as being limited to the implementations set forth herein. Like numbers refer to like, but not necessarily the same or identical, elements throughout.

The following drawing figures, which form a part of this application, are illustrative of described technology and are not meant to limit the scope of the technology as claimed in any manner, which scope shall be based on the claims appended hereto.

FIG. 1 illustrates a partial cutaway perspective view of a nuclear fission reactor, in accordance with some embodiments.

FIG. 2 is a top sectional view of a reactor core for a nuclear fission reacting, in accordance with some embodiments.

FIG. 3A is a partial elevation view of a nuclear fission reactor core, according to some embodiments.

FIG. 3B illustrates a fuel element with fuel and a tag gas capsule located therein, in accordance with some embodiments.

FIG. 4 illustrates, in a block diagram form, a sodium cooled fast reactor with a sampling sub-cell as part of the sodium processing system, in accordance with some embodiments.

FIG. 5 is a graph depicting radioactivity of Cesium-134 and Cesium-137 versus burnup, in accordance with some embodiments.

FIG. 6 illustrates a process for online radioisotope measurement for in-cell failed fuel characterization, in accordance with some embodiments.

FIG. 7 is a graph showing mass ratios of Xenon isotopes versus burnup, in accordance with some embodiments.

FIG. 8 illustrates a process for identifying and locating a failed fuel assembly within a nuclear reactor core, in accordance with some embodiments.

FIG. 9 illustrates a process for identifying and locating a failed fuel assembly within a nuclear reactor core, in accordance with some embodiments.

### DETAILED DESCRIPTION

The disclosure sets forth example embodiments and, as such, is not intended to limit the scope of embodiments of the disclosure and the appended claims in any way. Embodiments have been described above with the aid of functional building blocks illustrating the implementation of specified functions and relationships thereof. The boundaries of these functional building blocks have been arbitrarily defined herein for the convenience of the description. Alternate boundaries can be defined to the extent that the specified functions and relationships thereof are appropriately performed.

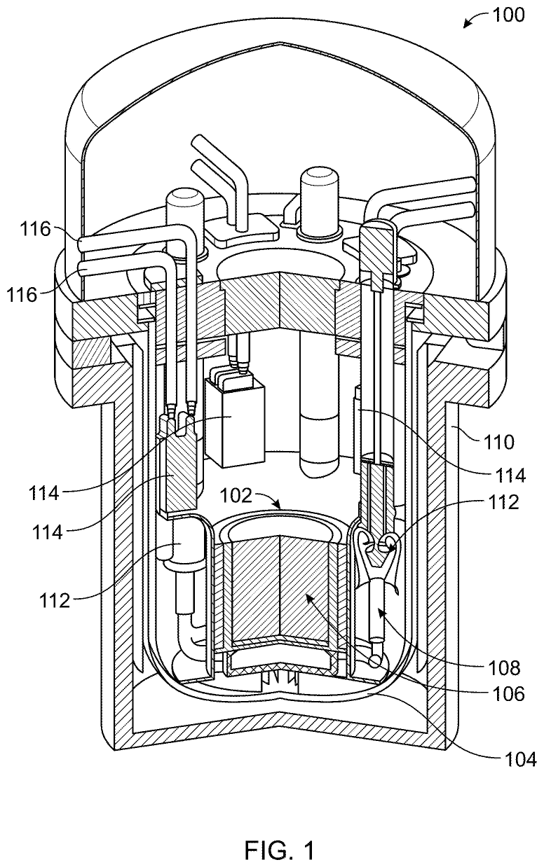

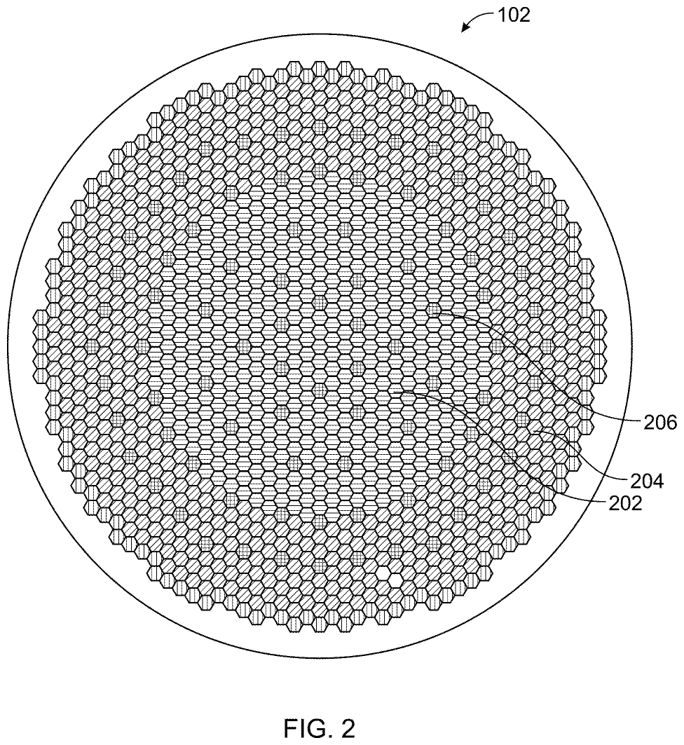

FIGS. 1 and 2 illustrate a fission reactor and reactor core as a non-limiting overview and not by way of limitation. As shown, nuclear fission reactor 100 includes a nuclear fission reactor core 102 disposed in a reactor vessel 104. According to some embodiments, nuclear fission reactor core 102 contains nuclear fuel within a central core region 106. Nuclear fission reactor core 102 may include fissile nuclear fuel assemblies 202, fertile nuclear fuel assemblies 204, and movable reactivity control assemblies 206. In some embodiments, nuclear fission reactor core 102 may include only fissile nuclear fuel assemblies 202 and fertile nuclear fuel assemblies 204. According to some embodiments, an in-vessel handling system (not shown) is configured to shuffle ones of the fissile nuclear fuel assemblies 202 and ones of the fertile nuclear fuel assemblies 204 within the reactor core 102. Nuclear fission reactor 100 may also include a reactor coolant system 108.

In some implementations, the nuclear fission reactor 100 is based on elements of liquid metal-cooled, fast reactor technology. For example, in various embodiments the reactor coolant system 108 includes a pool of liquid sodium disposed in the reactor vessel 104. In such cases, the nuclear fission reactor core 102 is submerged in the pool of sodium coolant in the reactor vessel 104. The reactor vessel 104 may be surrounded by a containment vessel 110 that helps prevent loss of sodium coolant in the unlikely case of a leak from the reactor vessel 104.

In various embodiments, the reactor coolant system 108 includes a reactor coolant pump 112. The reactor coolant system 108 may include one pump, two pumps, or any suitable number of pumps. In addition, the pumps may be any suitable pump as desired (e.g., electromechanical, electromagnetic, etc.).

The reactor coolant system 108 may include one or more heat exchangers 114. Heat exchangers 114 may be disposed in the pool of liquid sodium. In some embodiments, heat exchangers 114 have non-radioactive intermediate sodium coolant on the other side of heat exchangers 114. To that end, heat exchangers 114 may be considered intermediate heat exchangers.

The pumps 112 may be configured to circulate primary sodium coolant through the nuclear fission reactor core 102. In some embodiments, the pumped primary sodium coolant exits the nuclear fission reactor core 102 at a top of the nuclear fission reactor core 102 and passes through one side of the heat exchangers 114. In some embodiments, heated intermediate sodium coolant is circulated via intermediate sodium loops 116 outside the containment vessel 110, such as to a steam generator, to a thermal storage system, or may be circulated to heat exchangers for still another use. The primary sodium coolant may be circulated within the reactor vessel, through the reactor core and through the fuel assemblies, and a volume of primary sodium may be sent beyond the reactor vessel to a sodium processing cell, as will be described in further detail.

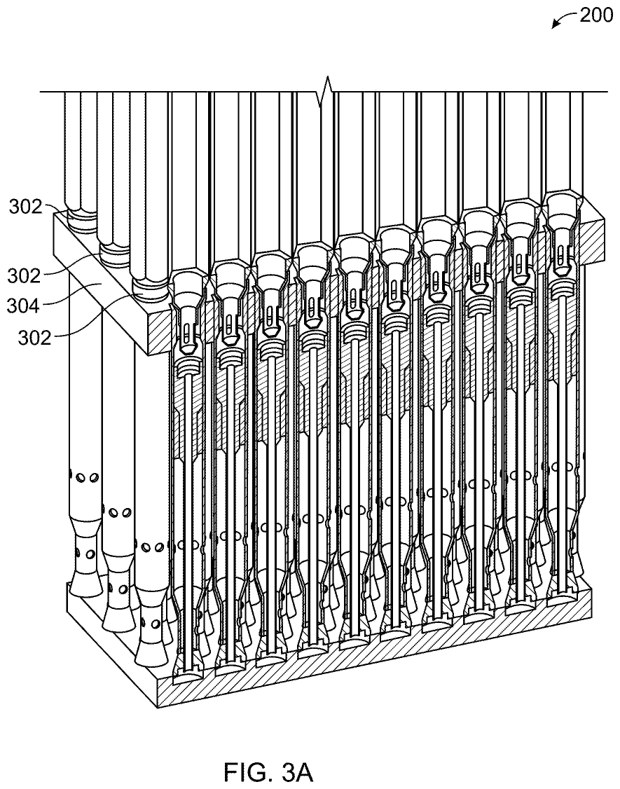

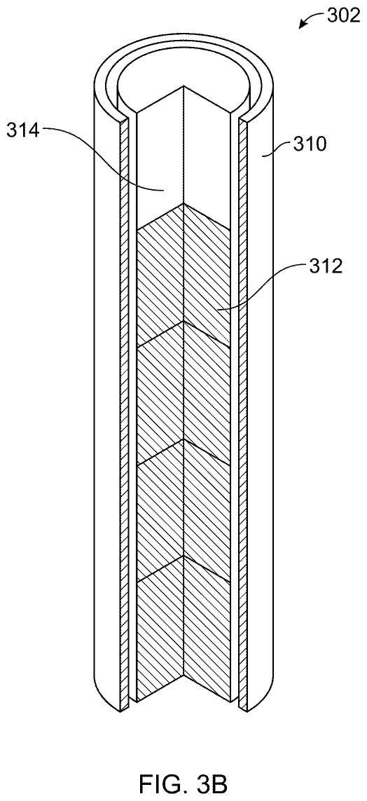

FIG. 3A illustrates a nuclear fission reactor core 100 that includes a plurality of nuclear fuel assemblies (e.g., fissile nuclear fuel assemblies 202, fertile nuclear fuel assemblies 204, movable reactivity control assemblies 206, etc.), shown as fuel assemblies 302. In some embodiments, fuel assemblies 302 may be supported in part by a core support grid plate 304. Primary sodium coolant flows through fuel assemblies 302, according to some embodiments to absorb heat generated by fuel within the fuel assemblies undergoing fission reactions.

In some embodiments, fuel assembly 302 includes a plurality of nuclear fuel pins (e.g., fuel rods, fuel elements, etc.), disposed within a duct that includes a tubular body. In some cases, the tubular body has a hexagonal cross-sectional shape as shown in FIGS. 2 and 3. In use, the primary sodium coolant flows upwardly into the fuel assemblies and around the fuel elements therein and draws heat away from the fuel assemblies and to the heat exchangers.

FIG. 3B illustrates a fuel element, which are typically long, slender bodies including a thin-walled outer jacket, or cladding 310. It should be appreciated that fuel element 302 need not be neutronically active. In some cases, the fuel element 302 need not contain any fissile material, but rather, may include neutronically reflective material, or fertile material, or a combination. In some cases, the fuel element 302 may contain fuel slugs 312 that may be stacked. Of course, the fuel element may contain any suitable fuel material and morphology, including extruded, annular, sponged, oxide, metal, among other types and shapes of nuclear fuel. In some cases, a tag gas capsule 314 may contain a tag gas (i.e., an identifying gas or mixtures of gasses). According to some embodiments, the tag gas capsule 314 may be loaded with specially blended gasses, such as one or more of isotopes of krypton or xenon isotopes. In some examples, once the tag gas capsules 314 are loaded into the fuel elements 302 and sealed, the tag gas capsules 314 may be pierced to allow the tag gas within the capsule to escape into the fuel element. In this way, if the fuel element 302 ever develops a leak, the tag gas may be released, and the defect core assembly can be located according to the embodiments described herein. In some cases, the tag gas capsule 314 may be formed into an end cap, or may be disposed internal to the fuel assembly. According to some embodiments, the tag gas capsule 314 releases its gas contents upon the fuel assembly reaching a desired temperature, thus the tag gas capsule 314 may remain intact until the fuel assembly is disposed within an operating nuclear reactor core. At a time after installation in the fuel assembly, the tag gas capsule 314 may be ruptured, pierced, breached, or otherwise unsealed to allow the tag gas to flow into the fuel assembly.

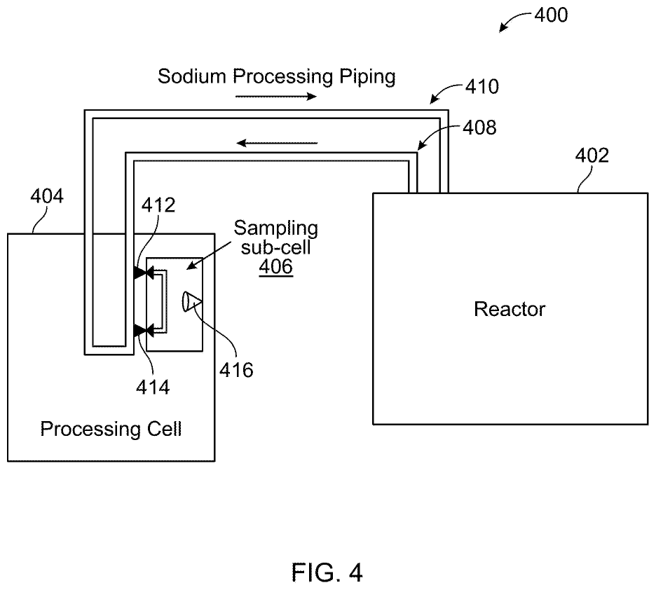

FIG. 4 illustrates a system 400 that includes a sodium-cooled nuclear reactor 402. The nuclear reactor 402 has a reactor core in which fuel elements are disposed. As shown in relation to FIG. 3, fuel elements are typically long, slender bodies including a thin-walled, outer jacket (also called cladding) and a fertile and/or fissionable composition (including fissionable nuclear fuel) within the cladding. Depending on the design of the nuclear reactor, multiple fuel elements are typically co-located into a fuel bundle or fuel assembly, and multiple fuel assemblies are included in the nuclear reactor. The geometric shape of the fuel element can be any suitable shape designed for the physical and design constraints of the fuel assembly and the nuclear reactor.

In conventional nuclear reactors, during irradiation in the reactor core, the fuel expands due to, for example, the production of fission products and, in particular, fission products in the form of gas. The fuel expands within the available space of the inner diameter of the cladding of an individual fuel element. However, over time and at higher burn-up values, the expansion of the fuel can strain the cladding, particularly where gas retention occurs and when fission products (gas or solid) begin to fill voids within the fuel. At this point, cladding strain may become proportional to burn-up and cladding strain may begin to increase rapidly. The filling of the available space within the cladding leads to a buildup of pressure that results in hoop stress, longitudinal stress and strain, and deformation of the fuel element. This strain ultimately limits the life of fuel elements in the reactor core as expansion of the fuel cladding leads to decreased (sometimes non-uniform) coolant flow areas external to the cladding. The rate of strain is increased by the constant effect of radiation on the structural material (e.g., cladding material and fuel assembly ducts). The fuel elements can expand enough to impart further strain on the duct wall of their associated fuel assemblies, which may become ‘jammed’ together due to the swelling and/or cause bowing of the fuel assembly. The fuel element swelling may sometimes cause cracks in the cladding which can lead to uncontrolled release of fission products and/or coolant interaction with the fuel. In a sodium cooled fast reactor, for example, liquid sodium flows around the fuel elements and where a fuel element fails (e.g., cracks or otherwise ruptures), the sodium coolant contacts the fuel and interacts with the fuel and fission products.

In some embodiments, the sodium travels from the reactor 402 through a sodium outlet pipe 408 to a sodium processing cell 404. A sampling sub-cell 406 may be located within the processing cell 404 for measuring emissions from a sodium sample. After measurements are taken, the sodium may travel through a sodium inlet pipe 410 back to the reactor 402. In some cases, the sodium flow loop from the reactor 402, through the outlet pipe 408, through the sodium processing cell 404, and back to the reactor 402 through the sodium inlet pipe 410 is a closed fluid system. As used herein, a closed fluid loop or closed fluid system refers to pipes, valves, pumps, and other fluid transport apparatus that is closed to the ambient environment. A closed fluid loop is one in which the fluid does not leave the loop once it has been introduced.

In some cases, the sampling sub-cell 406 may be configured to isolate a sodium sample, such as by valves 412, 414 that allow sodium to flow into the sub-cell 406 and then be isolated therein by closing the valves 412, 414. The sampling sub-cell 406 may contain a radiation detector/spectrometer 416 positioned near and/or adjacent the pipe within the sampling sub-cell 406 in order to measure radiation emitted from the sodium sample in the pipe. The valves 412, 414 allow the pipe to be isolated, among other reasons, to allow short lived isotopes (e.g., ²⁴Na) to decay in order to reduce background signals. In some cases, the radiation detector 416 is configured to measure gamma emissions from the sodium in the sampling sub-cell 406.

According to some embodiments, a method for characterizing failed fuel in sodium fast reactors (SFRs) uses measurements of gamma emissions to determine isotopic quantities and ratios of failed fuel products in the primary sodium coolant. By allowing sodium coolant to flow to the sodium processing cell 404 and into the sampling sub-cell 406, a failed fuel assembly can be characterized without the need to pull, process, and analyze primary sodium samples physically drawn from the reactor coolant for characterization of failed fuel products.

Typical prior approaches to characterizing failed fuel included removal of primary sodium samples for radioisotope analysis. These methods required handling of radioactive primary sodium, necessary sodium sample preparation equipment, generation of hazardous and radioactive wastes during sample processing, and time taken to analyze samples of primary sodium. Other prior approaches required removing the fuel assemblies from the reactor core in order to detect leakage.

According to some embodiments, characterizing failed fuel can be done in-situ by characterizing radioisotopes in primary sodium that has passed to the sampling sub-cell 406 which can be used for determining isotopic ratios of failed fuel constituents present in the primary coolant. This allows for determining the burnup of the failed fuel assembly, which in turn, can be correlated to a location of the failed fuel assembly within the core.

As used herein, the term “burn-up,” also referred to as “% FIMA” (fissions per initial heavy metal atom) refers to a measure (e.g., a percentage) of fission that occurs in fissile fuel. For example, a burn-up of 5% may indicate that 5% of the fissionable fuel underwent a fission reaction. Due to a number of factors, burn-up may not occur evenly along the length of each individual fuel element in a fuel assembly. Similarly, different fuel elements and fuel assemblies will each have different burnups based upon factors such as location in the core, length of time in the core, length of time at various locations within the core, volume of fuel in the assembly, fuel enrichment, among others. A fuel element is considered exhausted when a region of the fuel element has undergone enough burn-up to reach a burn-up limit, also sometimes referred to as a “peak burn-up” or “maximum burn-up.” When any one location reaches the burn-up limit, the entire fuel element is considered discharged even though only a portion of the fuel within that element has actually reached the discharge limit. In contrast to peak or maximum burn-up, the term “actual burn-up” may be used herein to refer to an amount of burn-up that has occurred within a defined area of the fuel assembly at the time when the fuel element is considered discharged because at least a portion of the fuel within the fuel element has reached the burn-up limit. According to embodiments herein, the isotopic ratios of failed fuel constituents may be used to determine isotopic ratios corresponding with either peak burn-up, actual burn-up, and/or average burn-up of a fuel element.

Traditionally, gas tagging is a method that has been used to identify a failed fuel element and includes the addition of a small amount of gas to a fuel element with a unique isotopic composition for each fuel assembly. When a fuel assembly develops a leak and releases fission products from the pressurized fuel element into the primary coolant, the tag gas can be detected, such as by mass spectrometric analysis of the reactor vessel cover gas. For example, gas tagging may utilize inert gases such as krypton and xenon. The unique tag gas compositions could be achieved with preferential enrichment of any of a number of isotopes, such as ⁷⁸Kr, ⁸⁰Kr, ⁸²Kr, ¹²⁶Xe, and ¹²⁹Xe to name a few. The isotopic ratios could be used, such as ⁷⁸Kr/⁸⁰Kr, ⁸²Kr/⁸⁰Kr, or ¹²⁶Xe/¹²⁹Xe to determine which of the fuel assemblies has failed. This technique may be successful in identifying a failed fuel element and a location; however, tag gas manufacture is expensive, especially considering that each fuel assembly requires a unique tag gas, and thus, each fuel assembly requires a unique manufacturing process. In some cases, this requires up to 168 or more unique tag gases in order to provide a unique tag gas for each fuel assembly.

According to some embodiments, high burnup fuels are utilized in the fuel assemblies and the tag system that is typically used is not viable on high burnup fuels due to the reduction of the band gaps between the different numerous tag gases. For example, on past reactors, the tag gases became indistinguishable since the tag gas was being directly depleted and fission products (such as Xe and Kr) also changed the composition. Embodiments described herein, such as the isotopic cesium ratios, allow down sampling of the possible failed fuel assemblies to a much smaller subset of possible fuel assemblies. Furthermore, using fewer tag gases than there are fuel assemblies offers a significant cost savings, but perhaps more importantly, offers a tag gas system that is able to be used with high-burnup fuels, as the traditional tag gas system fails in a high-burnup fuel. As used herein, the term “high-burnup fuel” is a broad term and in some cases, refers to a fuel with greater than around 6% FIMA.

However, according to embodiments described herein, fission gases are able to identify a failed fuel assembly without requiring a unique tag gas to be manufactured into each fuel assembly, thus drastically simplifying the manufacture of fuel elements, which may all be manufactured to be nearly identical using the same materials and processes. For example, by using fewer tag gases than there are fuel assemblies, larger bands (i.e., initial mass differences of the tag gasses) are used so that higher levels of depletion and fission gas additions will continue work to determine a failed fuel assembly even with a lower number of unique tag gasses. According to some embodiments, a lower number of unique tag gasses is enabled by having additional metrics, such as direct fission product sampling, to allow a further down selection of the failed fuel assembly.

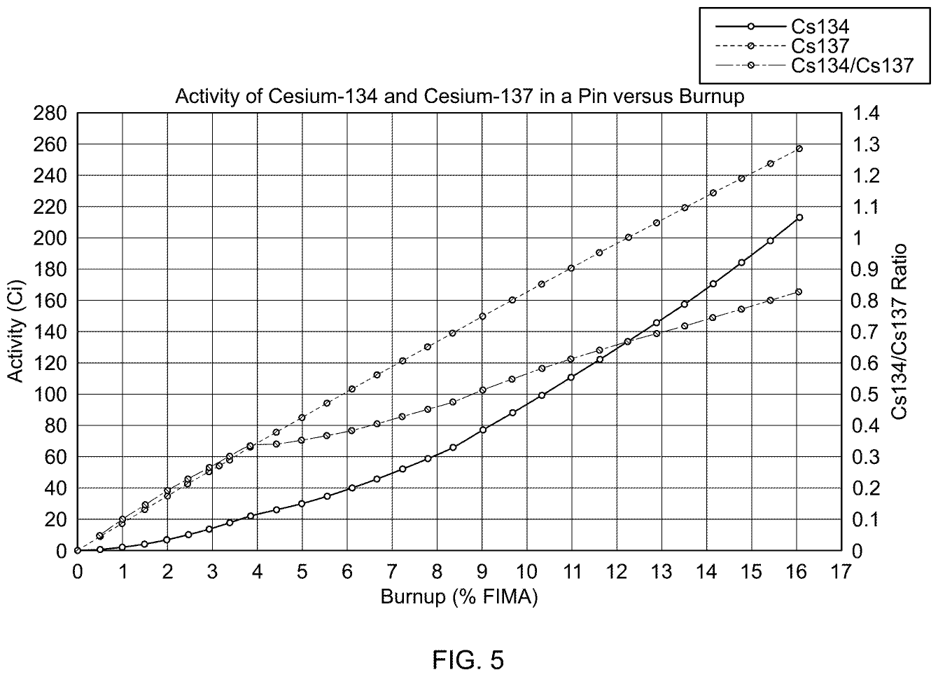

FIG. 5 illustrates a graph of ¹³⁷Cs/¹³⁴Cs as a function of burnup. As shown, ¹³⁷Cs exhibits a linear activity as a function of burnup. In contrast, ¹³⁴Cs is non-linear, which allows a measured ratio of ¹³⁷Cs/¹³⁴Cs to correspond with a specific fuel burnup within a fuel assembly. A mass spectrometer can be used to measure the mass of ¹³⁷Cs and ¹³⁴Cs, determine the isotopic ratio, and based on the isotopic ratio, determine a fuel burnup. Through core tracking and modeling, the burnup can be correlated with an individual fuel assembly.

While the isotopic ratio may be determined by mass spectroscopy, gamma ratios may also be used to determine activity, which is linked to burnup, and ultimately, identification of a failed fuel assembly. Radiocesium decays by beta emission to a metastable nuclear isomer of barium, ^{137m}Ba. Metastable barium has a half-life of about 153 seconds and is responsible for all of the gamma ray emissions associated with ¹³⁷Cs as it decays to the ground state (¹³⁷Ba) by emission of photons.

In some embodiments, the sodium background radiation is reduced to allow a more accurate measurement of the gamma emissions from the ¹³⁷Cs, which may be done by isolating a sodium coolant sample in the sampling sub-cell 406 for a predetermined period of time. The gamma emissions will pass through the piping in the sampling sub-cell 406 and reach the detector 416. The detector can then identify the activity of both the ¹³⁷Cs and ¹³⁴Cs to determine the burnup of the failed fuel assembly. However, in some cases, the background radiation may be characterized, such as prior to gamma testing, and the background radiation may be subtracted out of the gamma spectroscopy results to increase the resolution of the isotopic ratio.

According to some embodiments, determining the fuel assembly burnup by isotopic ratios allows the identification of a failed fuel assembly without unique tag gases in each fuel assembly. In some nuclear reactor embodiments, upwards of 168 or more fuel assemblies may be present in the core, which would thus require unique tag gases. In some embodiments, batches of fuel may be separated by burnup, which allows efficiencies when combined with a tag gas system that reuses tag gases for a group of fuel assemblies. For example, by separating fuel assemblies by burnup, a fewer number of tag gases may be used, such as 28 rather than 168 to distinguish failed fuel assemblies by coupling the failed fuel assembly tag gas identification with the isotopic ratio and burnup. In determining a location of a failed fuel assembly, the batch of the failed fuel assembly can be determined by a tag gas, and the cesium isotopic ratio provides additional information for identifying the failed fuel assembly.

According to some embodiments, a tag gas system may incorporate a number of unique tag gases that is fewer than the number of fuel assemblies. For example, the ratio of the number of unique tag gases to the number of fuel assemblies may be less than 50%, or 40%, or 30%, or 20%, or 17%or less. As an example, in a reactor core containing 168 fuel assemblies, 28 unique tag gases may be inserted into the fuel elements during manufacture. When a fuel element fails, an analysis of the cover gas will identify a tag gas, which in turn, down samples the number of possible fuel assemblies by identifying the group to which the failed fuel assembly belongs, thus narrowing the identification of the fuel assembly to one of 6 possible fuel assemblies. Similarly, if only 6 unique tag gases are used during fuel manufacture, the presence of a tag gas in an analysis of the cover gas will narrow the identification of the failed fuel assembly to at least one of 28 fuel assemblies. An analysis of the primary coolant can be used to ascertain the isotopic ratio, which then provides the burnup of the failed fuel assembly. By down sampling the number of possible fuel assemblies that failed, and by further down sampling the number of possible fuel assemblies by burnup, reactor modeling and core tracking can be used to identify the specific failed fuel assembly with a known location within the reactor core. Additionally, once the down selected fuel assemblies are determined, further analysis can be performed on the likely failed fuel assemblies. For example, once the number of failed fuel assemblies has been down sampled, an additional inspection technique, such as a lift and burp technique, may be employed to ascertain which of the likely failed fuel assemblies has actually failed. This provides substantial improvements in efficiencies over prior processes, which typically must inspect each fuel assembly throughout the core to determine which assembly has failed.

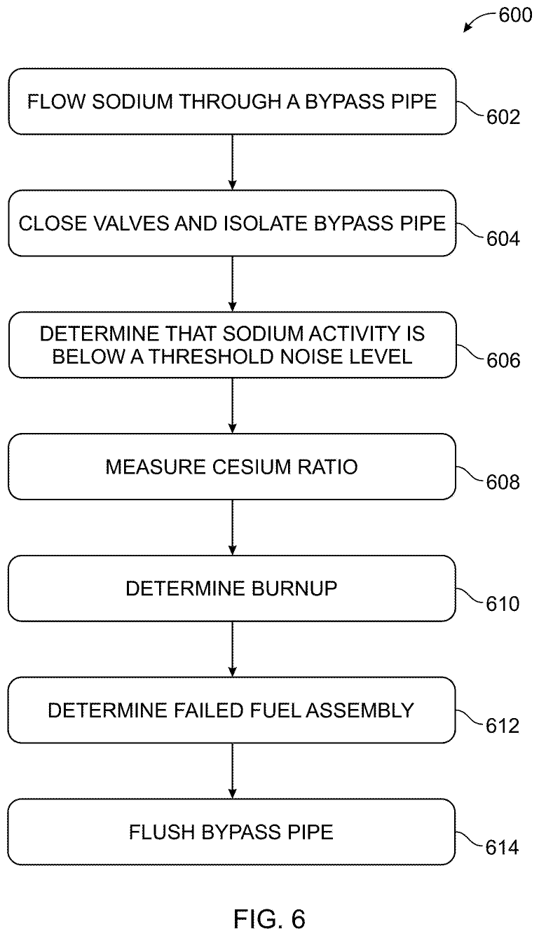

FIG. 6 illustrates a process flow for identifying and locating a failed fuel assembly 600. At step 602, primary sodium flows through a bypass pipe. The bypass pipe may optionally include a cesium trap which may be used to concentrate the cesium to allow for a larger signal. The bypass pipe may be located in a sodium processing cell, and may be located in sampling sub-cell within the sodium processing cell.

At step 604, the sodium sample may be isolated, such as by closing one or more valves to isolate the sodium sample from the sodium flow loop. This allows the sodium sample to remain stationary in the bypass pipe and provides time for the short-lived decay products to disperse. A detector can be in proximity to the pipe such that it can detect emissions from the sodium sample. In some example embodiments, the detector is used to measure isotopic ratios once the sodium enters the bypass pipe without providing time for the short-lived decay products to disperse. In some example embodiments, the sodium is allowed to flow continuously, and the detector is used to measure isotopic ratios of the flowing sodium stream. In some cases, measuring the isotopic ratios in a flowing stream of sodium ameliorates the need for a bypass pipe and the detector may be placed in proximity of the sodium loop without requiring a bypass pipe.

At block 606, the method may include determining that the high-energy sodium activity is below a threshold noise level. This provides that short-lived isotopes, such as ²⁴Na for example, decay to reduce the background signals prior to measuring the isotopic cesium ratios. This may be done, for example, by isolating the sodium sample for a predetermined period of time. Of course, as explained above, the previous steps are optional and, in some cases, the flowing sodium is measured to ascertain the isotopic cesium ratios, which may ameliorate the need for a bypass pipe and valves to isolate the bypass pipe all together and the detectors may be located near a sodium pipe and can continuously measure the isotopic ratios of the flowing sodium.

At block 608, the detector may be used to measure the isotopic cesium ratios. In some cases, this includes the ratio ¹³⁷Cs/¹³⁴Cs. In some embodiments, a mass spectrometer is used to measure the isotopic ratios. In some embodiments, a gamma detector is used to determine the isotopic ratio. The detector may be any suitable detector, such as, without limitation, a radiation dosimeter, radiographic films (e.g., NaI scintillation detector), thermoluminescence detector (TLD detector), a diode detector, high purity germanium detector (HPGe detector), or some other suitable gamma radiation detector.

At block 610, the isotopic ratio can be correlated with fuel element burnup. This may be done, for example, by a specialized computer program executed by one or more processors to determine, based on the isotopic ratios, a burnup, which may be an average burnup, peak burnup, or actual burnup of a fuel assembly.

At block 612, the burnup can be used to determine a failed fuel assembly. Through modeling and core tracking, the burnup of each fuel assembly can be ascertained, which can be compared with the burnup of the failed fuel assembly to thereby identify the failed fuel assembly along with its location within the reactor core. In some cases, a tag gas may be used to narrow the possible failed fuel assemblies, and the burnup can provide further information to narrow the identification of the failed fuel assembly. The number of unique tag gases may be less than the number of fuel assemblies.

At block 614, the bypass pipe may be flushed, such as by opening one or more valves, to allow the sodium sample to return to the sodium loop and back to the reactor. One particular advantage of fuel characterization through gamma spectroscopy, as described, is that it alleviates the traditional steps of shutting down the reactor and either withdrawing samples of radioactive sodium from the reactor vessel or withdrawing fuel assemblies from the core. As described herein, the systems and methods allow failed fuel characterization to be performed in-situ and while the reactor is operating without removing primary coolant from the system.

Once a failed fuel assembly has been identified, it can be scheduled to be replaced during scheduled reactor downtime rather than having to interrogate each of the fuel assemblies to find the failed assembly, find a suitable replacement, recalculate the core loading, approve the new core loading and then replace the fuel assemblies, which takes a significant amount of time during a shutdown, as would be required of traditional systems.

Identifying that a failure has occurred is routine and may be achieved by sampling the cover gas for the presence of fission products. During sampling of cover gas (either periodic or continuous), a reactor operator may learn that a fuel assembly has failed, such as by detecting fission products in the cover gas. The disclosed methods may then be carried out to determine which fuel assembly has failed. The disclosed system and methods allow the identification of the specific failed fuel assembly through detecting the isotopic ratios, determining burnup, and through computational modeling and core tracking, determine the fuel assembly having the determined burnup. In some cases, a tag gas may optionally help to down sample the number of likely candidates.

In some embodiments, the identity of the failed fuel assembly may not be ascertained, but rather, the information gathered from the burnup determination may down sample the likely candidates to fewer than all of the fuel assemblies in the core. In some cases, the techniques described herein may down sample the likely candidates to fewer than 50%, or fewer than 25%, or fewer than 10%, or fewer than 5% of all the fuel assemblies in the core. In these cases, an additional step may be taken to identify the specific failed fuel assembly. For example, once the fuel assemblies are down sampled, the candidate fuel assemblies may be lifted from the core which decreases the hydrostatic pressure and effectively increases the relative pin pressure, and may also reduce forced coolant flow through the assembly which thereby increases the temperature and relative pressure within the fuel elements within the fuel assembly. The increased hydrostatic pressure within the fuel assembly will cause fission gases to be expelled through any breaches in the cladding, and thus allow the identification of the failed fuel assembly. This process may be repeated for each candidate fuel assembly until the failed fuel assembly is identified. In some cases, this approach is known as a “lift-and-burp” technique. In some cases, the lift-and-burp technique may be applied during a refueling operation.

Although the foregoing description describes a fast sodium cooled reactor, this is for example purposes only and any solid fueled fission reactor may be used as appropriate.

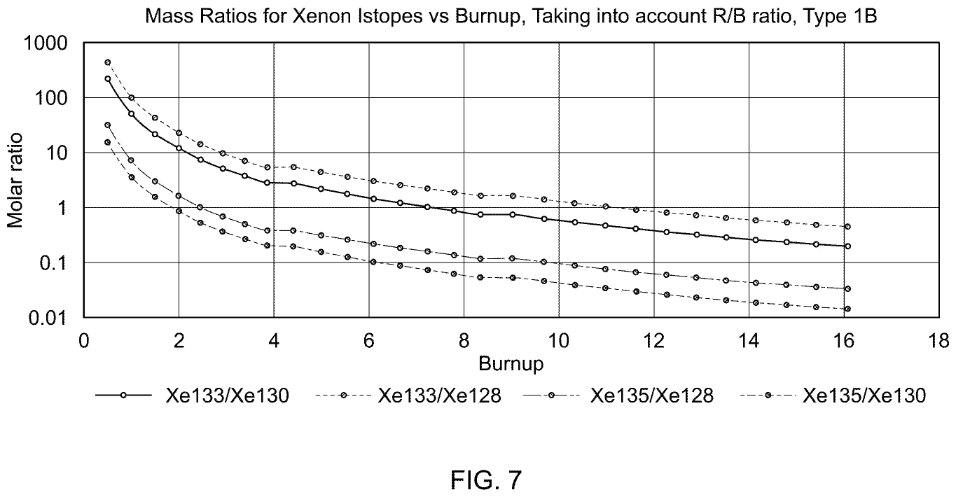

FIG. 7 is a graph of mass ratios of xenon isotopes as a function of burnup. This illustrates the radioactive to nonradioactive ratio of key xenon isotopes. During irradiation in the core, fission gases will be generated, and different isotopes will be present in the fuel element. When a fuel element fails, the fission gases are released into the cover gas, which can be detected according to embodiments described herein. A radioactive and stable isotope of Xe may be released from a failed fuel element and their ratio can be compared. The stable isotope does not decay; therefore, its inventory is increasing linearly with burnup, which is in contrast with a radioactive isotope, which will reach an equilibrium concentration where each atom that decays is replaced by a new one from fission. Not all of the inventory is released from the fuel pin as it must migrate out of the fuel, up the column and out of the pin. The fraction of gas that makes it to the cover gas space relative to how much is actually generated by fission is referred to as the release to birth ratio (“R/B”). The shorter the half-life, the lower the R/B. Therefore, the R/B ratio is taken into account when determining the ratio of stable and radioactive isotopes generated versus what is measured. By selecting radioactive isotopes that are at the same concentration at some point during the lifetime, a reliable sensitivity is achieved. At some point, the ratio of the radioactive and nonradioactive isotopes reach equilibrium at 1, and identifying these ratios can be directly correlated with burnup of the failed fuel element.

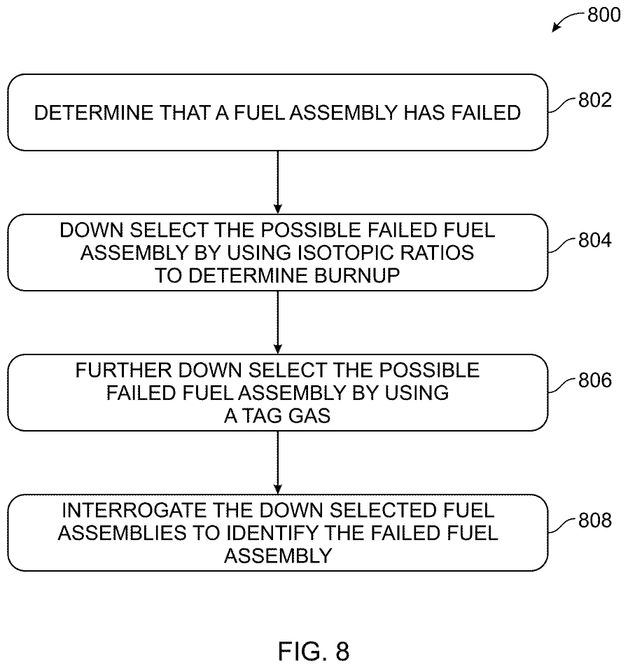

FIG. 8 illustrates a process for identifying and locating a failed fuel assembly 800 within a nuclear reactor core. According to some embodiments, a method includes, at block 802, determining that a fuel assembly has failed. This may be performed through any suitable process, and in some cases, may be determined by analyzing a cover gas for fission products.

At block 804, the candidates for the failed fuel assembly are down selected by using isotopic ratios to determine burnup. The burnup can be correlated to a first subset of fuel assemblies that have the approximate burnup associated with the failed fuel assembly. As a non-limiting example, the failed fuel assembly will cause cesium to enter the primary coolant. The primary coolant can be analyzed, such as through gamma spectroscopy, to determine the cesium isotopic ratio, which can be correlated to fuel burnup in the failed fuel assembly.

At block 806, the first subset of fuel assemblies can be further down sampled to a second subset of fuel assemblies based upon a tag gas. As described, a tag gas may be used within fuel elements and as the tag gas is detected, it can be used to further down sample the likely failed fuel assemblies. As described elsewhere herein, unique tag gases may be used within groups of fuel assemblies. For example, a first tag gas may be used in a first group of fuel assemblies, a second tag gas may be used in a second group of fuel assemblies, and a third tag gas may be used in a third group of fuel assemblies. By down sampling the likely failed fuel assemblies through isotopic ratios to a first subset, the first subset can be further down sampled to a second subset by detecting a tag gas of the failed fuel assembly. In some cases, the second subset will include a single fuel assembly, which will be the failed fuel assembly. In some cases, the second subset will identify a number of fuel assemblies that may have failed. In this case, as shown at block 808, the fuel assemblies in the second subset can be interrogated to identify the failed fuel assembly. For example, the fuel assemblies in the second subset can be lifted and burped, or have some other investigative technique used, to determine which fuel assemblies of the second subset have failed.

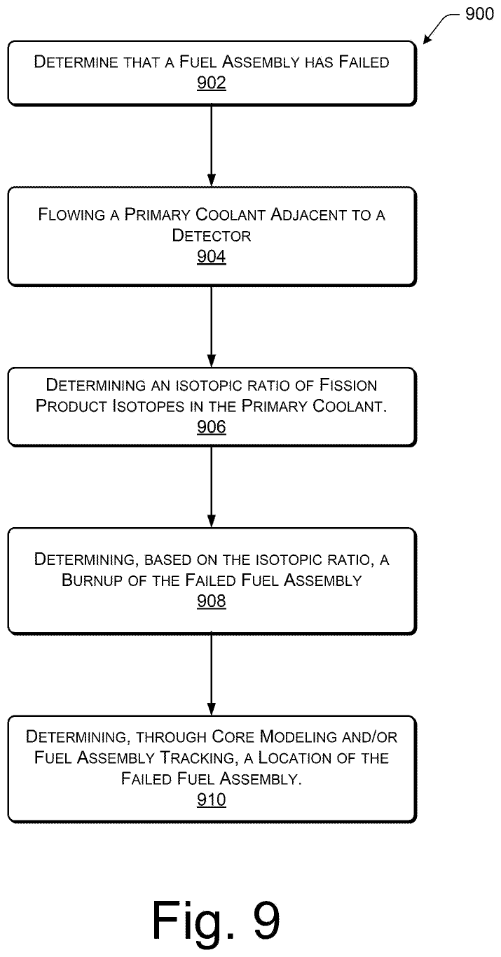

FIG. 9 illustrates a process for identifying and locating a failed fuel assembly 900 within a nuclear reactor core. According to some embodiments, a method includes, at block 902, determining that a fuel assembly has failed. This may be performed through any suitable process, and in some cases, may be determined by analyzing a cover gas for fission products, a wet sipping technique, a dry sipping technique, or some other technique.

At block 904, a primary coolant is past adjacent a detector. The primary coolant may be routed through a bypass pipe that directs an inventory of primary coolant adjacent a detector.

At block 906, the method includes determining an isotopic ratio of fission product isotopes in the primary coolant. This may be performed by any suitable technique, such as any of the techniques described herein in relation to the various embodiments disclosed.

At block 908, the method includes determining, based on the isotopic ratio, a burnup of the failed fuel assembly. In some cases, the burnup can be correlated to a first subset of fuel assemblies that have the approximate burnup associated with the failed fuel assembly. As a non-limiting example, the failed fuel assembly will cause cesium to enter the primary coolant. The primary coolant can be analyzed, such as through gamma spectroscopy, to determine the cesium isotopic ratio, which can be correlated to fuel burnup in the failed fuel assembly.

At block 910, the method may determine a location of the failed fuel assembly, which can be performed by using core modeling and/or fuel assembly tracking during the fuel cycle of the nuclear reactor core. Further steps may be included, for example, using a tag gas to down select, or specifically identify, the failed fuel assembly. In some cases, the suspected failed fuel assemblies may be interrogated to determine which one or ones of the suspected fuel assemblies has failed.

Of course, the down sampling techniques need not be performed in the illustrated order. For example, a first down sampling may be performed by tag gas analysis to determine a first subset, and the first subset may then be further narrowed by analyzing for burnup associated with a measured isotopic ratio. In this way, a failed fuel assembly can quickly be ascertained, which in many cases, can be accomplished in-situ (e.g., without having to remove a fuel assembly from the core for testing), and also while the reactor is operating.

The foregoing description of specific embodiments will so fully reveal the general nature of embodiments of the disclosure that others can, by applying knowledge of those of ordinary skill in the art, readily modify and/or adapt for various applications such specific embodiments, without undue experimentation, without departing from the general concept of embodiments of the disclosure. Therefore, such adaptation and modifications are intended to be within the meaning and range of equivalents of the disclosed embodiments, based on the teaching and guidance presented herein. The phraseology or terminology herein is for the purpose of description and not of limitation, such that the terminology or phraseology of the specification is to be interpreted by persons of ordinary skill in the relevant art in light of the teachings and guidance presented herein.

The breadth and scope of embodiments of the disclosure should not be limited by any of the above-described example embodiments, but should be defined only in accordance with the following claims and their equivalents.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

Unless otherwise noted, the terms “connected to” and “coupled to” (and their derivatives), as used in the specification, are to be construed as permitting both direct and indirect (i.e., via other elements or components) connection. In addition, the terms “a” or “an,” as used in the specification, are to be construed as meaning “at least one of.” Finally, for ease of use, the terms “including” and “having” (and their derivatives), as used in the

The specification and annexed drawings disclose examples of systems, apparatus, devices, and techniques that may provide control and optimization of coolant flow through core assemblies. It is, of course, not possible to describe every conceivable combination of elements and/or methods for purposes of describing the various features of the disclosure, but those of ordinary skill in the art recognize that many further combinations and permutations of the disclosed features are possible. Accordingly, various modifications may be made to the disclosure without departing from the scope or spirit thereof. Further, other embodiments of the disclosure may be apparent from consideration of the specification and annexed drawings, and practice of disclosed embodiments as presented herein. Examples put forward in the specification and annexed drawings should be considered, in all respects, as illustrative and not restrictive. Although specific terms are employed herein, they are used in a generic and descriptive sense only, and not used for purposes of limitation.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

The methods described in relation to embodiments herein may be implemented by one or more processors executing instructions that cause the processors to carry out the disclosed methods.

Throughout the instant specification, the term “substantially” in reference to a given parameter, property, or condition may mean and include to a degree that one of ordinary skill in the art would understand that the given parameter, property, or condition is met with a small degree of variance, such as within acceptable manufacturing tolerances. By way of example, depending on the particular parameter, property, or condition that is substantially met, the parameter, property, or condition may be at least approximately 90% met, at least approximately 95% met, or even at least approximately 99% met.

From the foregoing, it will be appreciated that, although specific implementations have been described herein for purposes of illustration, various modifications may be made without deviating from the spirit and scope of the appended claims and the elements recited therein. In addition, while certain aspects are presented below in certain claim forms, the inventors contemplate the various aspects in any available claim form. For example, while only some aspects may currently be recited as being embodied in a particular configuration, other aspects may likewise be so embodied. Various modifications and changes may be made as would be obvious to a person skilled in the art having the benefit of this disclosure. It is intended to embrace all such modifications and changes and, accordingly, the above description is to be regarded in an illustrative rather than a restrictive sense.

The following numbered clauses also form a part of the disclosure.

Clause 1. A method for characterizing a failed fuel assembly in a nuclear reactor, comprising: flowing a primary sodium coolant to a bypass pipe; determining an isotopic ratio of ¹³⁷Cs/¹³⁴Cs within sodium in the bypass pipe; determining, based at least in part on the isotopic ratio, a burnup of the failed fuel assembly; and determining, based at least in part on the burnup, an identification of the failed fuel assembly.

Clause 2. The method of clause 1, wherein determining the isotopic ratio is performed by gamma spectroscopy.

Clause 3. The method of any of clauses 1-2, wherein the method is performed without removing primary sodium coolant from a closed system comprising a nuclear reactor vessel and the bypass pipe.

Clause 4. The method of any of clauses 1-3, further comprising determining, by analyzing a cover gas in a reactor vessel and detecting a fission product in the cover gas, that a fuel assembly has failed.

Clause 5. The method of any of clauses 1-4, further comprising determining a Xenon isotopic ratio by mass spectroscopy.

Clause 6. The method of any of clauses 1-5, further comprising providing a tag gas to one or more fuel elements within a fuel assembly.

Clause 7. The method of clause 6, wherein providing a tag gas comprises providing a plurality of unique tag gases and wherein a number of unique tag gases is less than a number of fuel assemblies located within a nuclear reactor core.

Clause 8. The method of any of clauses 1-7, wherein the method is carried out during reactor operation.

Clause 9. The method of any of clauses 1-8, wherein determining an identification of the failed fuel assembly comprises determining a subset of fuel assemblies, the subset of the fuel assemblies comprising one or more of the failed fuel assemblies.

Clause 10. The method of clause 9, further comprising analyzing ones of the subset of the fuel assemblies to determine a failed fuel assembly.

Clause 11. The method of clause 10, wherein analyzing ones of the subset of the fuel assemblies comprises a lift and burp technique.

Clause 12. The method of any of clauses 1-11, further comprising isolating the sodium coolant in the bypass pipe.

Clause 13. A system, comprising: a nuclear reactor core; a plurality of fuel elements disposed in the nuclear reactor core; a volume of primary sodium coolant in contact with the plurality of fuel elements; a sodium processing cell external to the nuclear reactor core, the sodium processing cell in fluid communication with the nuclear reactor core by sodium processing piping; a detector adjacent the sodium processing piping, the detector configured to detect radioactive emissions of isotopes that escaped from a failed fuel assembly; one or more processors configured with instructions that, when executed by the one or more processors, cause the processors to: determine isotopic ratios of the isotopes; determine, based at least in part on the isotopic ratios, a burnup of the failed fuel assembly; and determine, based at least in part on the burnup of the failed fuel assembly, a location of the failed fuel assembly within the nuclear reactor core.

Clause 14. The system of clause 13, further comprising a plurality of unique tag gases located within selected ones of the plurality of fuel elements disposed in the nuclear reactor core.

Clause 15. The system of clause 14, wherein a number of the plurality of unique tag gases is fewer than the number of fuel assemblies.

Clause 16. The system of clause 13, wherein the detector is configured to detect gamma emissions from the isotopes that escaped from a failed fuel assembly through gamma spectroscopy.

Clause 17. The system of clause 13, further comprising a cover gas processing system configured to measure the isotopes that escaped from a failed fuel assembly within a cover gas.

Clause 18. The system of clause 17, wherein the isotopes that escaped from the failed fuel assembly are xenon isotopes.

Clause 19. The system of clause 13, wherein the isotopes that escaped from a failed fuel assembly are cesium isotopes.

Clause 20. The system of clause 13, wherein the isotopic ratio is 137Cs/134Cs.

Clause 21. A method for locating a failed fuel assembly in a nuclear reactor, comprising: determining that a fuel assembly has failed; flowing a primary coolant adjacent to a detector; determining, with the detector, an isotopic ratio of fission product isotopes in the primary coolant; determining, based on the isotopic ratio, a burnup of the failed fuel assembly; and determining, based on the burnup of the failed fuel assembly and through core modeling and fuel assembly tracking, a location of the failed fuel assembly within the nuclear reactor.

Clause 22. The method of clause 21, wherein the isotopic ratio is 137Cs/134Cs.

Clause 23. The method of any of clauses 21-22, wherein the isotopic ratio of fission products isotopes in the primary coolant is performed by measuring gamma emissions.

Clause 24. The method of any of clauses 21-23, wherein the method is performed while the nuclear reactor is operating.

Clause 25. The method of any of clauses 21-24, wherein the method is performed without removing primary coolant from a closed coolant loop.

Clause 26. The method of any of clauses 21-25, wherein the step of determining, with the detector, an isotopic ratio of fission product isotopes in the primary coolant is performed on a flowing volume of sodium.

Clause 27. The method of any of clauses 21-26, further comprising detecting a tag gas from a failed fuel assembly.

Clause 28. A method for identifying a failed fuel assembly in a nuclear reactor core, comprising: determining that a fuel assembly has failed; down selecting possible failed fuel assemblies to a first subset of fuel assemblies by using isotopic ratios to determine burnup; down selecting the first subset to a second subset of fuel assemblies by using a tag gas; and determining, based at least in part on the burnup and the tag gas, the failed fuel assembly.

Clause 29. The method of clause 28, wherein burnup is determined by using gamma spectroscopy to detect an isotopic ratio.

Clause 30. The method of any of clauses 28-29, wherein the method is performed in-situ and without removing a volume of sodium coolant from the nuclear reactor core.

Clause 31. The method of any of clauses 28-30, wherein determining that a fuel assembly has failed is performed by analyzing a cover gas in a reactor vessel and detecting a fission product or a tag gas in the cover gas.

Clause 32. The method of clause 31, wherein detecting a fission product or a tag gas is performed by mass spectrometry.

Clause 33. The method any of clauses 28-32, wherein using a tag gas comprises providing a first tag gas to a first group of fuel assemblies, providing a second tag gas to a second group of fuel assemblies, and providing a third tag gas to a third group of fuel assemblies.

Clause 34. The method of any of clauses 28-33, wherein the method is carried out during reactor operation.

Clause 35. The method of any of clauses 28-34, further comprising analyzing the second subset of fuel assemblies using a lift and burp technique.

Clause 36. The method of any of clauses 28-35, wherein determining the failed fuel assembly is performed through core modeling and/or fuel assembly tracking.

What is claimed is:

1. A method for characterizing a failed fuel assembly in a nuclear reactor, comprising:
flowing a primary sodium coolant to a bypass pipe;
determining an isotopic ratio of ¹³⁷Cs/¹³⁴Cs within sodium in the bypass pipe;
determining, based at least in part on the isotopic ratio, a burnup of the failed fuel assembly; and
determining, based at least in part on the burnup, an identification of the failed fuel assembly.

2. The method of claim 1, wherein determining the isotopic ratio is performed by gamma spectroscopy.

3. The method of claim 1, wherein the method is performed without removing primary sodium coolant from a closed system comprising a nuclear reactor vessel and the bypass pipe.

4. The method of claim 1, further comprising determining, by analyzing a cover gas in a reactor vessel and detecting a fission product in the cover gas, that a fuel assembly has failed.

5. The method of claim 1, further comprising determining a Xenon isotopic ratio by mass spectroscopy.

6. The method of claim 1, further comprising providing a tag gas to one or more fuel elements within a fuel assembly.

7. The method of claim 6, wherein providing a tag gas comprises providing a plurality of unique tag gases and wherein a number of unique tag gases is less than a number of fuel assemblies located within a nuclear reactor core.

8. The method of claim 1, wherein the method is carried out during reactor operation.

9. The method of claim 1, wherein determining an identification of the failed fuel assembly comprises determining a subset of fuel assemblies, the subset of the fuel assemblies comprising one or more of the failed fuel assemblies.

10. The method of claim 9, further comprising analyzing ones of the subset of the fuel assemblies to determine a failed fuel assembly.

11. The method of claim 10, wherein analyzing ones of the subset of the fuel assemblies comprises a lift and burp technique.

12. The method of claim 1, further comprising isolating the sodium coolant in the bypass pipe.

13. A system, comprising:
a nuclear reactor core;
a plurality of fuel elements disposed in the nuclear reactor core;
a volume of primary sodium coolant in contact with the plurality of fuel elements;
a sodium processing cell external to the nuclear reactor core, the sodium processing cell in fluid communication with the nuclear reactor core by sodium processing piping;
a detector adjacent the sodium processing piping, the detector configured to detect radioactive emissions of isotopes that escaped from a failed fuel assembly;
one or more processors configured with instructions that, when executed by the one or more processors, cause the processors to:
determine isotopic ratios of the isotopes;
determine, based at least in part on the isotopic ratios, a burnup of the failed fuel assembly; and
determine, based at least in part on the burnup of the failed fuel assembly, a location of the failed fuel assembly within the nuclear reactor core.

14. The system of claim 13, further comprising a plurality of unique tag gases located within selected ones of the plurality of fuel elements disposed in the nuclear reactor core.

15. The system of claim 14, wherein a number of the plurality of unique tag gases is fewer than the number of fuel assemblies.

16. The system of claim 13, wherein the detector is configured to detect gamma emissions from the isotopes that escaped from a failed fuel assembly through gamma spectroscopy.

17. The system of claim 13, further comprising a cover gas processing system configured to measure the isotopes that escaped from a failed fuel assembly within a cover gas.

18. The system of claim 17, wherein the isotopes that escaped from the failed fuel assembly are xenon isotopes.

19. The system of claim 13, wherein the isotopes that escaped from a failed fuel assembly are cesium isotopes.

20. The system of claim 13, wherein the isotopic ratio is ¹³⁷Cs/¹³⁴Cs.
